(19) United States
(12) Patent Application Publication
(10) Pub. No.: US 2019/0206385 A1
(43) Pub. Date: Jul. 4, 2019

(54) VOCAL REPRESENTATION OF COMMUNICATION MESSAGES

(71) Applicant: Knowmail S.A.L LTD., Petach-Tikva (IL)

(72) Inventors: Oded Avital, Ganey Tiqua (IL); Avi Mandelberg, Hod Ha'Sharon (IL); Yury Gubman, Jerusalem (IL); Shmuel Ur, Shorashim (IL); Ariel Kedem, Netanya (IL)

(21) Appl. No.: 15/858,420

(22) Filed: Dec. 29, 2017

(51) Int. Cl. G10L 13/08; H04L 12/58; G06F 17/27

(52) U.S. Cl. CPC G10L 13/08; G10L 2015/0631; G06F 17/27; H04L 51/00

(57) ABSTRACT

A computer-implemented method, a computer program product and a computerized apparatus, the method comprising: receiving a communication message transmitted to a user; automatically generating a summary of at least a part of the communication message, the summary comprising: a sender, an object description, comprising a collection of terms describing a group of communication messages including the at least part of the communication message, and content including a summarization of the at least part of the communication message, wherein the content relates to the object; and generating an audio signal based on the summary, the audio signal adapted to be played to a user, whereby providing a summarized vocal description of the at least part of the communication message.

### TECHNICAL FIELD

The present disclosure relates to digital communication messaging systems in general, and to generating vocal representations thereof, in particular.

### BACKGROUND

Electronic-based communication messages, such as e-mails, instant messages, Short Message Service (SMS) messages, Whatsapp™ messages, Facebook™ private messages, or the like, are methods of exchanging digital messages between an author or sender and one or more recipients. E-mail is a prominent example of such communication system, which is referred to be herein as an example of a communication system.

Current communication systems are mostly client-server based. A server is an application that receives communication messages from clients, or from other servers. A server may serve a list of users, and may comprise or use a storage area, a set of user definable rules, and a series of communication modules. The storage area is where received communication messages are stored for local users, and where communication messages in transit to another destination are temporarily stored. It usually takes the form of a database of information.

A client is an application, used by users for reading, composing, sending and receiving communication messages. A client may be installed on a user's computing platform, but may additionally or alternatively be implemented as a web page accessed for example using a browser. The client usually comprises an editor, an address book, a folder collection or hierarchy in which messages may be stored, and communication modules. The address book allows users to store commonly used addresses in an easy to get at format, reducing the chance of addressing errors.

A communication system usually consists of one or more servers, each connected to a multiplicity of clients, each client associated with a user or another entity such as a group, a resource such as a room, or the like.

In normal operation mode, a client receives from the server communication messages sent by users within the organization or external to the organization. The user may view the received (or the sent) communication messages, and may order them in accordance with predetermined parameters, such as receipt date and time, sender, subject, or the like.

A user may receive communication messages on one or more devices, including a desktop computer, a laptop computer, a mobile phone, a tablet, or the like. Therefore, the user may also receive communication messages when in one of a multiplicity of states, including working, walking, driving or being engaged in any other activity.

### SUMMARY

One exemplary embodiment of the disclosed subject matter is a computer-implemented method comprising: receiving a communication message transmitted to a user; automatically generating a summary of at least a part of the communication message, the summary comprising: a sender, an object description, comprising a collection of terms describing a group of communication messages including the at least part of the communication message, and content including a summarization of the at least part of the communication message, wherein the content relates to the object; and generating an audio signal based on the summary, the audio signal adapted to be played to a user, whereby providing a summarized vocal description of the at least part of the communication message. The method can further comprise playing the audio signal to the user. The method can further comprise clustering the communication message and additional communication messages based on the sender, the object description or the content. Within the method, generating the object description optionally comprises: generating a feature vector representing the at least part of the communication message; generating additional feature vectors representing additional communication messages; clustering the feature vector and additional feature vectors to obtain a first multiplicity of clusters; selecting a cluster form the multiplicity of clusters containing the at least part of the communication message; and selecting the collection of terms as terms representing the cluster. Within the method, the feature vector or the additional feature vectors optionally include a feature selected from the group consisting of: a word appearing in the communication message, a length of the communication message, a synonym word to appearing in the communication message, a timestamp of the communication message, elapsed time since receipt of the communication message, word count of the communication message, a Natural Language Processing (NLP) feature, a part of speech feature, an NLP-based classification feature, and a bag-of-words based feature. The method can further comprise determining a group of communication messages including the communication message, wherein the summary describes the group of communication messages, thereby providing the summarized vocal of the group of communication messages. Within the method, determining the group of communication messages optionally comprises: determining a priority score for each message; determining message groups, wherein messages assigned to one message group have a same sender, a same object description or a same content; determining a priority score for each group; and selecting a group having a highest priority. Within the method, the priority score determined for each message is optionally different than a priority that would be assigned for a message that is to be visually displayed to a user. Within the method, the priority score determined for a message group is optionally based on priorities assigned to communication messages assigned to the group. Within the method, the audio generated for the group optionally comprises group information. Within the method, the group information optionally comprises information related to the same sender, the same object description or the same content. The method can further comprise generating residual audio for a message assigned to the group. The method can further comprise generating audio providing the entire text for a message assigned to the group. The method can further comprise generating another audio signal for the communication message or for another communication message based upon audio commands received from the user.

Another exemplary embodiment of the disclosed subject matter is a computerized apparatus having a processor, the processor being adapted to perform the steps of: receiving a communication message transmitted to a user; automatically generating a summary of at least a part of the communication message, the summary comprising: a sender, an object description, comprising a collection of terms describing a group of communication messages including the at least part of the communication message, and content including a summarization of the at least part of the communication message, wherein the content relates to the object; and generating an audio signal based on the summary, the audio signal adapted to be played to a user, whereby providing a summarized vocal description of the at least part of the communication message. Within the computerized apparatus, the processor is optionally further adapted to cluster the communication message and additional communication messages based on the sender, the object description or the content. Within the computerized apparatus, generating the object description optionally comprises: generating a feature vector representing the at least part of the communication message; generating additional feature vectors representing additional communication messages; clustering the feature vector and additional feature vectors to obtain a first multiplicity of clusters; selecting a cluster form the multiplicity of clusters containing the at least part of the communication message; and selecting the collection of terms as terms representing the cluster. Within the computerized apparatus, the feature vector or the additional feature vectors optionally include a feature selected from the group consisting of: a word appearing in the communication message, a length of the communication message, a synonym word to appearing in the communication message, a timestamp of the communication message, elapsed time since receipt of the communication message, word count of the communication message, a Natural Language Processing (NLP) feature, a part of speech feature, an NLP-based classification feature, and a bag-of-words based feature. Within the computerized apparatus, the processor is optionally further adapted to determine a group of communication messages including the communication message, wherein the summary describes the group of communication messages, thereby providing the summarized vocal of the group of communication messages.

Yet another exemplary embodiment of the disclosed subject matter is a computer program product comprising a computer readable storage medium retaining program instructions, which program instructions when read by a processor, cause the processor to perform: receiving a communication message transmitted to a user; automatically generating a summary of at least a part of the communication message, the summary comprising: a sender, an object description, comprising a collection of terms describing a group of communication messages including the at least part of the communication message, and content including a summarization of the at least part of the communication message, wherein the content relates to the object; and generating an audio signal based on the summary, the audio signal adapted to be played to a user, whereby providing a summarized vocal description of the at least part of the communication message.

### BRIEF DESCRIPTION OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method for generating vocal representation of a communication message, in accordance with some exemplary embodiments of the disclosed subject matter;

FIG. 2 shows a flowchart diagram of a method for generating an object description of a communication message, in accordance with some exemplary embodiments of the disclosed subject matter;

FIG. 3A shows a flowchart diagram of a method for grouping items, in accordance with some exemplary embodiments of the disclosed subject matter;

FIG. 3B shows a flowchart diagram of a method for generating a summary of a multiplicity of communication messages, in accordance with some exemplary embodiments of the disclosed subject matter; and

FIG. 4 is a schematic block diagram of a computing platform executing a server and a computing platform executing a client, in accordance with some exemplary embodiments of the disclosed subject matter.

### DETAILED DESCRIPTION

In the description below, the terms “message”, “communication”, “communication message”, “mail”, “e-mail”, “email”, are used interchangeably and refer to an electronic communication message that may be transmitted by an author or sender to one or more intended recipients, and may be consequently received by devices of such recipients. The term should be construed to exclude broadcasted messages, such as posts in a bulletin board, posts in a social network, or the like, which are not designated to a specific user or group of users, and which can be viewed by users who the message was not originally intended to. The term is not limited to any specific protocol. Exemplary protocols for transmitting such messages may include Simple Mail Transfer Protocol (SMTP), Post Office Protocol (POP3), Internet Message Access Protocol (IMAP), Short Message Service (SMS) or the like.

In the description below, unless indicated otherwise, the term “user” relates to a person using a client to consume communication messages sent thereto, for example listen to messages or read messages.

One technical problem dealt with by the disclosed subject matter is that currently users can receive communication messages on a multiplicity of devices such as a desktop computer a laptop computer, a mobile phone, a tablet, a personal digital assistant, or the like and in any state, including working at the office, being at home, walking, driving or the like. In some of these states, the user may be unable to read a written message which may be important or urgent and may thus miss an opportunity to refer to it at the right time. However, in some situations, and particularly when driving, the user may still wish to make good use of the time and consume received messages.

Another technical problem dealt with by the disclosed subject matter is that although text to speech technologies exist which can transform a written message to audio, simply listening to an entire message being read may be tedious and may take a long time even if the message is short and clear. Thus, it may be required to convey the essence of the message rather than the text as is.

Yet another technical problem dealt with by the disclosed subject matter is that some messages are more important than others and should thus be prioritized such that the user does not waste time listening to unimportant messages. It may be desired to achieve prioritization even when using vocal modality for consuming communication messages. Even further, the priority may change in accordance with the modality used for consuming the messages. For example, when listening to messages some messages may be assigned a higher or a lower priority than when messages are read by the user.

Yet another technical problem dealt with by the disclosed subject matter is that many times a message is part of a group of messages, also referred to as a conversation, wherein a user may be more interested in the essence of the whole conversation than in one particular message.

One technical solution refers to generating an audio signal representing a message, wherein the audio signal can be played to the user instead of or prior to the user reading the textual representation of the message. The audio signal can be played by a mobile phone in which the user receives the message, by a car audio system if the mail message arrives to a car communication system, by a smart speaker, such as AMAZON ECHO™ or GOOGLE HOME™, by any computerized device having a speaker, or the like.

The audio signal may comprise at least the sender of the message, a description of an object representing the message, and content including summarization of the message.

The sender may be an explicit sender's name appearing in the communication message. In some cases, the sender may be determined using an address book to match the sender's contact information with an entry in the address book. The sender's identification may be extracted from the entry.

An object representing the message may be a main topic discussed in the message, an event the message relates to, a conversation a message belongs to, or the like. Some exemplary objects of messages may be a meeting scheduled or discussed in the message, a planned trip, a subject of the message, or the like. The object may be calculated per communication messages, by clustering the communication messages, possibly from different channels, such as e-mails, chats, text messages, or the like. A cluster comprising the communication message being analyzed may be detected. The description of the cluster, such as a label, tag, or the like, may be used as the object of the message. In some exemplary embodiments, the clustering may be performed with respect to the user's communication messages, thereby providing personalized clustering and as a result personalized object determination.

The content can be the summary of the communication message, or a relevant part thereof. In some cases, the content may be summarized using topic extraction and text summarization methods.

Generating audio from the message and playing the text comprising the sender, the object description and the content may provide the user with the message in an efficient and crystalized manner.

Yet another technical solution refers to selecting a message to be read to a user. Selection can comprise grouping the messages based on the sender, the object or the content. Some messages may be grouped together based on having a same sender. Hence, several groups that are based on the sender may be determined. Additionally or alternatively, some messages may be grouped together based on sharing the same object. Additionally or alternatively, messages may be grouped based on sharing the same content. In some cases, groups may be based on messages sharing more than a single element, such as based on sharing the same sender and same object.

In some exemplary embodiments, a same message may be assigned to different groups, and the groups may have non-empty intersection.

The audio signal may be generated based on the group, such as by including in the audio signal shared information between the messages and providing an indication as to the size of the group. In some cases, the group may be identified first, and its content may be played only in case the group is selected by the user for further review. For example, the audio signal may be: “two messages from John”, “three messages about your meeting tomorrow”, “twenty messages wishing you happy holidays”, or the like. In some cases, in case the user decides to select a group of messages, each message in the group is represented without including the shared part. For example, if “two messages from John” are selected, the messages may be represented by their object and content without repeating the shared information of the sender's name (e.g., “Asking you to bring money to your meeting tomorrow” and “Saying he found a bug in the project”, instead of “A message from John asking you to bring money to your meeting tomorrow” and “a message from John about the project saying he found a bug”).

A priority score may be determined for each group to provide for an ordinal relationship therebetween. The priority score may be based on an aggregation of priority scores of the messages included in the group, such as a maximal priority score of the messages of the group, an average priority score of the messages of the group, or the like. Audio signals for each group may be generated and played in accordance with the order defined by their priority scores.

One technical effect of the disclosure relates to enabling a user to listen to messages prior to or instead of reading the messages, in order to make better use of the user's time, or timely receive important or urgent messages when the user cannot read the messages.

Another technical effect of the disclosure relates to providing the user with a summary of the message or part thereof rather than reading the whole message which may be tedious and take unnecessarily long time.

Yet another technical effect of the disclosure relates to providing messages in accordance with priority, such that more important messages are read first.

Yet another technical effect of the disclosure relates to providing audio representation of a group of messages, wherein the messages in the group share a sender, an object or content, such that the user receives the whole picture and not just a single message.

The disclosed subject matter may provide for one or more technical improvements over any pre-existing technique and any technique that has previously become routine or conventional in the art.

Additional technical problem, solution and effects may be apparent to a person of ordinary skill in the art in view of the present disclosure.

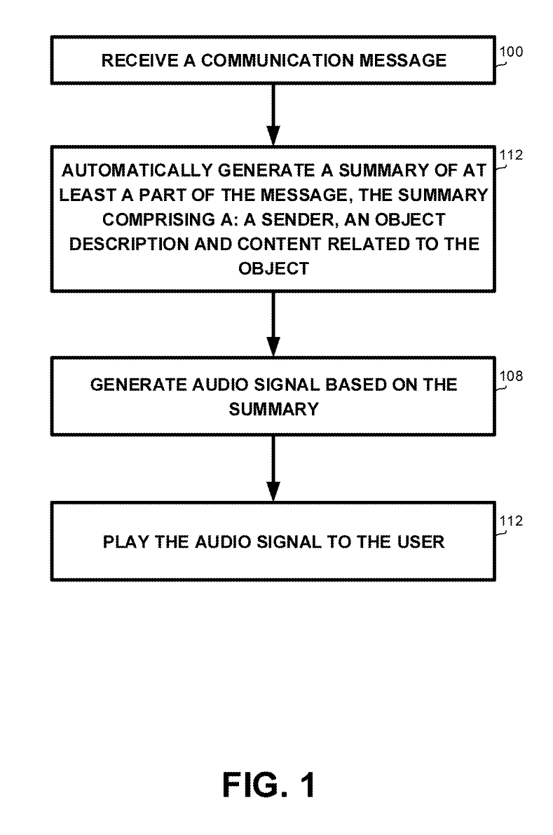

Referring now to FIG. 1, showing a flowchart diagram of a method for generating vocal representation of a communication message, in accordance with some exemplary embodiments of the disclosed subject matter.

On step 100, a communication message may be received by a message server. The message may be received on any channel and under any protocol.

On step 104, a summary of at least part of the communication message may be automatically generated, the summary determined by matching the message to a template comprising: a sender of the message, an object description of the message, and content of the message related to the object.

The sender may be identified by the display name, by a unique address such as an e-mail address, by the name in which the user's device identifies the sender, or the like.

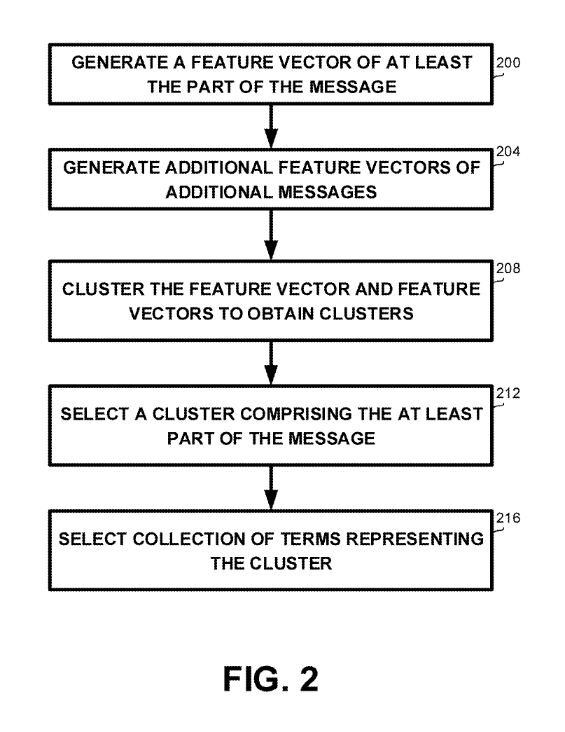

Generating the object description is further detailed in association with FIG. 2 below.

The content of the message may be generated based upon any topic extraction or text summarization technique currently known or that will become known in the future, which is applied to the body of the message.

In some cases, a message may refer to some topics or otherwise be comprised of a multiplicity of subjects. In such cases, the object description and the content may relate to one or more of the parts of the message, each associated with one topic.

In some exemplary embodiments, a summery of a group of messages may be determined, such as based on the shared elements of the messages. In some cases the summary of the group may further comprise an elaborated summery which includes a remainder summery of each message detailing the non-shared elements.

On step 108, an audio signal based on the summary may be automatically generated. The audio signal may be generated by processing the summary using text-to-speech engine, possibly with additions of predefined text, such as “A message received from”, or the like.

On step 112, the audio signal may be read to a user using a playing engine such as a corresponding application, and a speaker such that the user can hear the summary.

Referring now to FIG. 2, showing a flowchart diagram of a method for generating an object description of a communication message, in accordance with some exemplary embodiments of the disclosed subject matter.

On step 200, a feature vector of at least a part of the message is extracted. The feature vector may be based on various attributes and metadata of the messages, such as but not limited to one or more words in the message, the length of the message, synonym words, timestamp, elapsed time since receipt of the message, word count, or any other characteristics of the message. Additional features may be extracted using Natural Language Processing (NLP) techniques, and the feature vectors may include NLP features such as but not limited to parts of speech features, NLP-based classification features, or Bag-of-Words based features.

On step 204, feature vectors are extracted also for other messages, for example other messages of the user, whether received over the same media or in other channels, for example e-mails, text messages, instant messages, or the like. In some embodiments, for example when the method is performed at the organization level, feature vectors of messages of other users may also be extracted.

On step 208, the feature vector extracted on step 204 and the feature vectors extracted on step 208 may be clustered, to obtain a first set of clusters. Clustering can be performed using any method, such as K-means clustering, hierarchical clustering, spectral clustering, NLP-based classification, graph-based communities or the like. In further embodiments, Machine Learning classification and/or clustering techniques may be applied. Additionally or alternatively, rule-based clustering may be utilized. The number of clusters and their sizes may be defined by data driven machine learning techniques and/or by pre-defined rules. In some exemplary embodiments, messages that are members of the same cluster are considered similar or having similar characteristics. Common membership may be deemed as representing the fact that the messages relate to the same object.

It is noted that in some cases, a same message may be represented by two or more feature vectors, such as in case the message comprises a multiplicity of subjects, each subject may be individually represented.

Additionally or alternatively, the clusters may have a same message may appear in two or more clusters. For example, a message relating to a meeting and to a project, may be automatically associated with the cluster representing the meeting and the cluster representing the project.

Clustering may include identifying common characteristics to the messages in each cluster, such as terms which are common to all messages in the group, terms common to a multiplicity of messages in the group, or the like.

On step 212, the cluster comprising the communication message, i.e., the cluster to which the message has been assigned, can be selected.

On step 216, the terms characterizing the cluster, as detailed above, such as one or more attributes and metadata of the messages, including but not limited to one or more words in the messages or synonym words, message length, message timestamp or range thereof, elapsed time since receipt of the message, word or others, may be determined as the object description of the message.

It will be appreciated that the terms extracted for each message, and optionally intermediate clustering results, may be stored and reused for extracting the subject of future messages as well. Additionally or alternatively, a multiplicity of messages may be processed simultaneously, such that the object description of all these messages is extracted using one clustering operation.

It will be appreciated that if there are no other messages in the cluster comprising the message, then extracting the terms and providing them as the object description may be omitted. Additionally or alternatively, the title of the message, if any, may be selected as the object description.

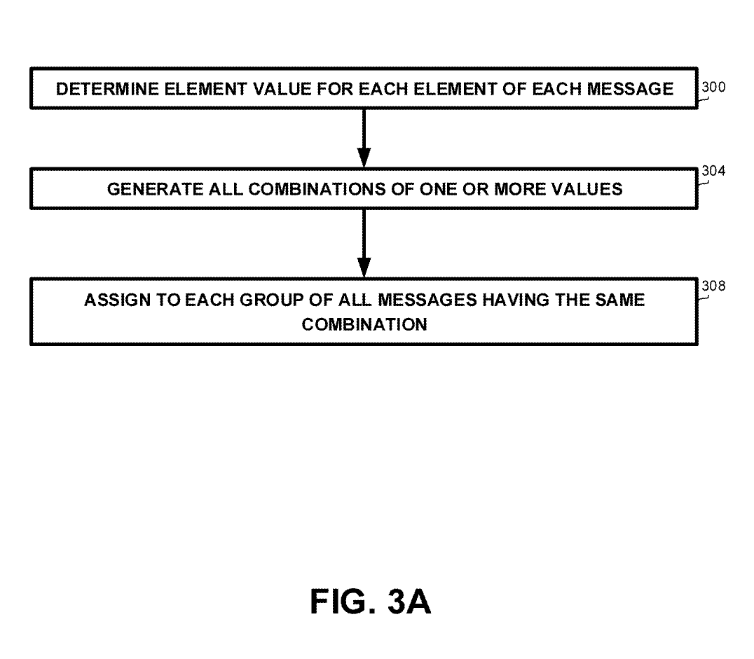

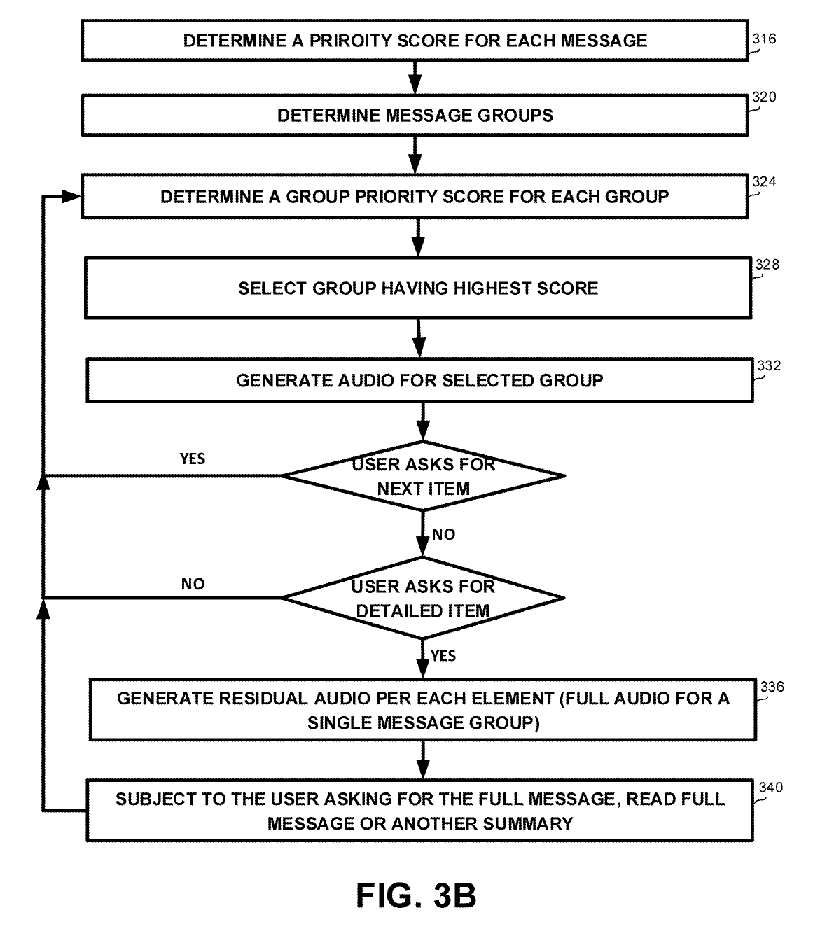

Referring now to FIG. 3A, showing a flowchart diagram of a method for grouping items, wherein each item is a message, in accordance with some exemplary embodiments of the disclosed subject matter.

On step 300, a value is determined for each of the three elements comprised in a summary of a communication message, being the sender, the object and the content. Retrieving the sender of a message is generally straight forward. The object description may be obtained as detailed in association with FIG. 2 above, and the content may be generated using any summarization technique.

On step 304, all combinations of one or more values, i.e. one value, two values or three values may be generated, and a group may be established for each such combination.

On Step 308, each message is assigned to one or more groups associated with the values assigned to the message. It will be appreciated if three elements are considered, a message may be assigned to up to multiple groups, including at least three groups having a single element value, at least three groups having two element values and at least one group having three element values, and more groups if a message has multiple senders, or multiple contents if it relates to multiple topics, or the like).

Referring now to FIG. 3B, showing a flowchart diagram of a method for generating a summary of a multiplicity of communication messages, in accordance with some exemplary embodiments of the disclosed subject matter.

On step 316, a priority score may be determined for each message. The priority of a single message, or a part thereof, can be determined in accordance with default rules, user rules, organization rules or a combination thereof. A priority assigned to a message may vary in accordance with the modality through which the user consumes the messages. Thus, the priority assigned to a message when audio related to the message is to be played may differ than the priority assigned when messages are to be visually displayed.

On step 320 message groups may be determined, for example as detailed in association with FIG. 3A above.

On step 324 priority may be assigned to each group. The priority may be based on the priorities of the particular messages assigned to each group, for example, maximal priority, average priority, or the like. In some embodiments, the priority of a group may be affected the number of messages in the group. Thus, a group with a single message having a priority of 0.8 may be assigned a lower priority than a group having a hundred messages each with priority of 0.8. In some embodiments, the priority of a group may be affected the number of element values the group is based on. For example, a group generated upon three element values may be assigned a higher score than a group generated upon two element values, which may be assigned a higher score than a group generated upon one element value. In further embodiments, the priority may also be affected by the number or percentage of messages in the group which have not been read to a user yet. Thus, if all messages in the group have already been assigned to other groups and have been read as part of reading the other groups, the group may be assigned a priority of zero or another small value. In some embodiments, each group may be treated as a unit with its own features, such as location, internet domain or the like, and these features may be used when determining a score for the group may be scored using these features, in addition or alternatively to applying some function to priorities or scores of items in the group.

On step 328, an item, which may be a group comprising one or more messages is selected in accordance with the priorities, for example the group with the highest priority may be selected.

On step 332, audio may be generated for the group. The audio may be generated upon text relevant to the group, and processing the text with a speech to text engine. If the group is a single message group, the three element values may be read, i.e. the sender, object and content. Otherwise, as detailed above the audio may include the number of messages in the group, values common to the messages in the group, or the like.

If the user then asks to hear the next group, execution may return to step 324 for reassigning priorities to the groups. Reassigning may be required since a priority of a group may change if all messages in the group have already been read to the user. Alternatively, a group that has been read to a user may be deleted such that no priority is calculated for it and it cannot be selected.

If the user does not ask for the next group, then if the user does not ask for detailing of the current group, execution may again return to step 324.

If the user does ask for detailing the current group, then on step 336 residual audio may be generated for each message in the group. Residual audio may include audio related to an element that was not read before. For example, for example if the group shares a sender and the sender name was already read, it will not be repeated. The residual audio may also include metadata such as “message X out of Y”, or the like.

If the user then asks for further detailing of a particular message for example after the message is read, additional audio may be generated, for example the entire text of the message may be read, or a different summary of the message may be generated and read. In some embodiments, such summary may be extracted using NLP tools, one or more pre-defined rules or technologies.

It will be appreciated that the user asking for the next group or for further details, or any other user interface command may be performed by using visual menus or options, or by providing audio commands using a vocal user interface, such that the user does not have to look at a displayed menu. In some embodiments, vocal user interface may also be provided for the user to respond, forward or perform another action with a message.

It will be appreciated that the priority can be determined for each set of clusters immediately or anytime after clustering is completed, and not necessarily as a separate step.

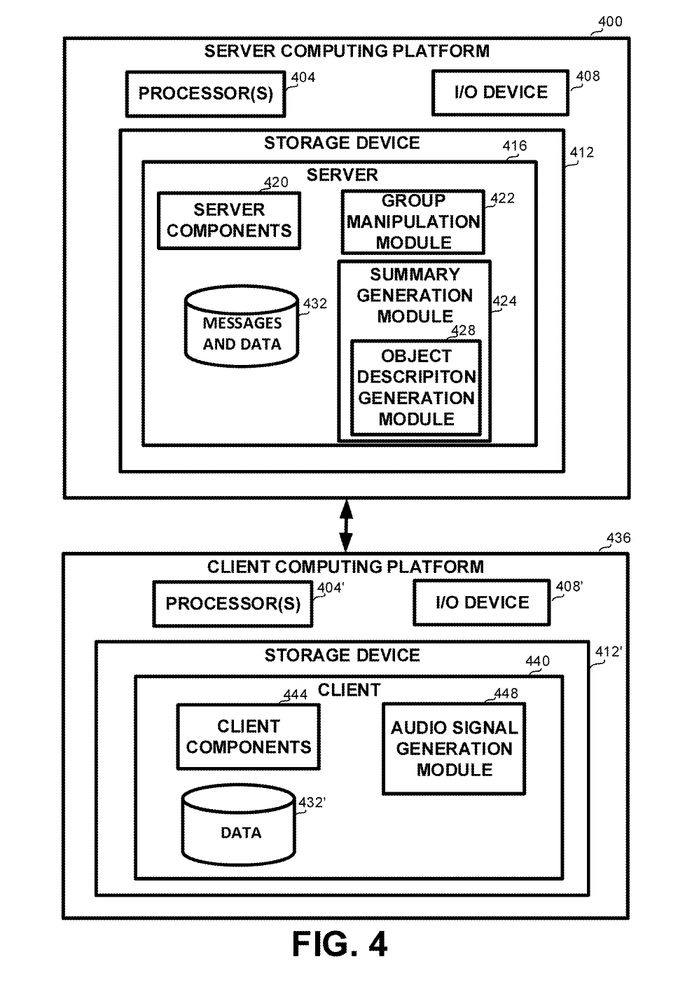

Referring now to FIG. 4, showing a schematic block diagram of a computing platform 400 executing a server and a computing platform 436 executing a client, in accordance with some exemplary embodiments of the disclosed subject matter.

In some exemplary embodiments, server computing platform 400 may be a server, a desktop computer, a mobile computer, or the like.

Computing platform 400 may comprise one or more processor(s) 404. Processor 404 may be a Central Processing Unit (CPU), a microprocessor, an electronic circuit, an Integrated Circuit (IC) or the like. Processor 404 may be utilized to perform computations required by the apparatus 400 or any of it subcomponents.

In some exemplary embodiments of the disclosed subject matter, computing platform 400 may comprise an Input/Output (I/O) device 408 such as a display, a pointing device, a keyboard, a touch screen, or the like. I/O device 408 may be utilized to provide output to and receive input from a user.

In some exemplary embodiments, computing platform 400 may comprise a storage device 412. Storage device 412 may be a hard disk drive, a Flash disk, a Random Access Memory (RAM), a memory chip, or the like. In some exemplary embodiments, storage device 412 may retain program code operative to cause the processor 404 to perform acts associated with any of the subcomponents of computing platform 400. The components detailed below may be implemented as one or more sets of interrelated computer instructions, executed for example by processor 404 or by another processor. The components may be arranged as one or more executable files, dynamic libraries, static libraries, methods, functions, services, or the like, programmed in any programming language and under any computing environment.

Storage device 412 may store server 416, for managing the communication message services server computing platform 400. Server 416 may comprise server components 420 which provide the regular functionality of a communications server, such as communication with users and with other servers, user and account management, security, backup, or the like.

Server 416 may comprise group manipulation module 422 for creating groups in accordance with the element values, assigning messages to groups, determining group priority, or the like.

Server 416 may further comprise summary generation module 424 which may comprise or otherwise activate object description generation module 428.

Summary generation module 424 may receive a message and generate a textual summary upon which vocal representation of the message can be obtained. The summary may comprise a sender of the message, an object description and content.

Object description generation module 428 can obtain an object description for a message, for example by extracting a feature vector from the message and from additional messages, and clustering the feature vectors, as described above.

Storage device 412 may store messages and data 432, for example in one or more databases, each of which may be comprised in, or otherwise operatively connected storage device 412. Messages and data 432 may comprise messages sent to or received by the user or by other users, or data related thereto, for example extracted feature vectors, clustering results, priorities, or the like.

Client computing platform 436 is in communication with server computing platform 400. It will be appreciated that a multiplicity of client computing devices 436 can communicate with one or more server computing platforms 400.

Client computing platform 436 may comprise processor 404′, I/O device 408′ and storage device 412′ analogous to processor 404, I/O device 408 and storage device 412′ of server computing platform 400. It will be appreciated, however, that /O device 408′ comprises a speaker, such as earphones, headphones, loud speaker, car speaker or others, through which an audio signal may be played.

Client computing platform 436 may comprise a client 440, which may comprise client components 444, and audio signal generation module 448.

Client components 444 are responsible for the normal operation of the communication client, such as an e-mail client, including for example operations such as communication with a server, folder management, backup, or the like.

Audio signal generation module 448 can receive a text describing one or more messages, and output an audio file or stream of the messages, using for example text to speech techniques.

Client computing platform 436 can comprise or be operatively associated with data 432′ stored on one or more databases. Data 432′ can comprise communication messages of the user, and associated data such as a folder hierarchy, user scores, message texts, priorities, or the like.

It will be appreciated that server computing platform 400 and client computing platform 436 or parts thereof can be implemented on one or more machines. For example, server computing platform 400 and client computing platform 436 can be implemented on one machine accessed through the Internet. In alternative embodiment, server computing platform 400 and client computing platform 436 can be implemented on one machine, and only audio signal generation module 448 may be implemented on a user's device. It will be appreciated that multiple other implementation combinations can be designed and used.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
receiving a communication message transmitted to a user;
automatically generating a summary of at least a part of the communication message, the summary comprising:
a sender,
an object description, comprising a collection of terms describing a group of communication messages including the at least part of the communication message, and
content including a summarization of the at least part of the communication message, wherein the content relates to the object; and
generating an audio signal based on the summary, the audio signal adapted to be played to a user,
whereby providing a summarized vocal description of the at least part of is the communication message.

2. The method of claim 1, further comprising playing the audio signal to the user.

3. The method of claim 1, further comprising clustering the communication message and additional communication messages based on the sender, the object description or the content.

4. The method of claim 1, wherein generating the object description comprises:
generating a feature vector representing the at least part of the communication message;
generating additional feature vectors representing additional communication messages;
clustering the feature vector and additional feature vectors to obtain a first multiplicity of clusters;
selecting a cluster form the multiplicity of clusters containing the at least part of the communication message; and
selecting the collection of terms as terms representing the cluster.

5. The method of claim 4 wherein the feature vector or the additional feature vectors include a feature selected from the group consisting of: a word appearing in the communication message, a length of the communication message, a synonym word to appearing in the communication message, a timestamp of the communication message, elapsed time since receipt of the communication message, word count of the communication message, a Natural Language Processing (NLP) feature, a part of speech feature, an NLP-based classification feature, and a bag-of-words based feature.

6. The method of claim 1, further comprising determining a group of communication messages including the communication message, wherein the summary describes the group of communication messages, thereby providing the summarized vocal of the group of communication messages.

7. The method of claim 6, wherein determining the group of communication messages comprises:
determining a priority score for each message;
determining message groups, wherein messages assigned to one message group have a same sender, a same object description or a same content;
determining a priority score for each group; and
selecting a group having a highest priority.

8. The method of claim 7, wherein the priority score determined for each message is different than a priority that would be assigned for a message that is to be visually displayed to a user.

9. The method of claim 7, wherein the priority score determined for a message group is based on priorities assigned to communication messages assigned to the group.

10. The method of claim 7, wherein the audio generated for the group comprises group information.

11. The method of claim 10 wherein the group information comprises information related to the same sender, the same object description or the same content.

12. The method of claim 7, further comprising generating residual audio for a message assigned to the group.

13. The method of claim 7, further comprising generating audio providing the entire text for a message assigned to the group.

14. The method of claim 1, further comprising generating another audio signal for the communication message or for another communication message based upon audio commands received from the user.

15. A computerized apparatus having a processor, the processor being adapted to perform the steps of:
receiving a communication message transmitted to a user;
automatically generating a summary of at least a part of the communication message, the summary comprising:
a sender,
an object description, comprising a collection of terms describing a group of communication messages including the at least part of the communication message, and
content including a summarization of the at least part of the communication message, wherein the content relates to the object; and
generating an audio signal based on the summary, the audio signal adapted to be played to a user,
whereby providing a summarized vocal description of the at least part of the communication message.

16. The computerized apparatus of claim 15, wherein the processor is further adapted to cluster the communication message and additional communication messages based on the sender, the object description or the content.

17. The computerized apparatus of claim 15, wherein generating the object description comprises:
generating a feature vector representing the at least part of the communication message;
generating additional feature vectors representing additional communication messages;
clustering the feature vector and additional feature vectors to obtain a first multiplicity of clusters;
selecting a cluster form the multiplicity of clusters containing the at least part of the communication message; and
selecting the collection of terms as terms representing the cluster.

18. The computerized apparatus of claim 17, wherein the feature vector or the additional feature vectors include a feature selected from the group consisting of:
a word appearing in the communication message, a length of the communication message, a synonym word to appearing in the communication message, a timestamp of the communication message, elapsed time since receipt of the communication message, word count of the communication message, a Natural Language Processing (NLP) feature, a part of speech feature, an NLP-based classification feature, and a bag-of-words based feature.

19. The computerized apparatus of claim 15, further comprising determining a group of communication messages including the communication message, wherein the is summary describes the group of communication messages, thereby providing the summarized vocal of the group of communication messages.

20. A computer program product comprising a computer readable storage medium retaining program instructions, which program instructions when read by a processor, cause the processor to perform:
receiving a communication message transmitted to a user;
automatically generating a summary of at least a part of the communication message, the summary comprising:
a sender,
an object description, comprising a collection of terms describing a group of communication messages including the at least part of the communication message, and
content including a summarization of the at least part of the communication message, wherein the content relates to the object; and
generating an audio signal based on the summary, the audio signal adapted to be played to a user,
whereby providing a summarized vocal description of the at least part of the communication message.
